(19) United States
(12) Patent Application Publication
(10) Pub. No.: US 2009/0161503 A1
(43) Pub. Date: Jun. 25, 2009

(54) METHOD AND OPTICAL DRIVE FOR DETECTING A HEADER REGION ON AN OPTICAL CARRIER

(75) Inventor: Xinyan Wu, Southampton (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/092,981

(22) PCT Filed: Nov. 8, 2006
(86) PCT No.: PCT/IB2006/054155

§ 371 Date: May 8, 2008

(30) Foreign Application Priority Data
Nov. 14, 2005 (CN) 200510124718.2

(51) Int. Cl. G11B 7/00

(52) U.S. Cl. 369/44.25; G9B/7

(57) ABSTRACT

The present invention relates to a method of detecting a header region for a writeable optical carrier. The method initially obtains a data signal (RF) from the optical carrier, and performs a low pass filtering the data signal (RF) for a pre-determined time constant. Subsequently, there is performed a comparison between the low pass filtered data signal (LPF_RF) and a dynamically determined threshold level (RF_th), whereby a positive indication of a header region (I, II, III) is obtained, if the low pass filtered data signal (LPF_RF) is above the dynamically determined threshold level (RF_th). In an advantageous embodiment, there is further performed a comparison of a polarity signal (DPII) to a previous polarity signal (DPI) so as to provide an indication of a land-groove transition. The present invention provides a simple and robust method of detection and header region and possibly a land-groove transition compared to the hitherto known solutions.

### FIELD OF THE INVENTION

The present invention relates to a method of detecting a header region for a writeable optical carrier. Such optical carriers may in particular include a digital versatile disc of the read access memory format (DVD-RAM). The invention also relates to a corresponding optical drive.

### BACKGROUND OF THE INVENTION

Optical storage of information on optical carriers or disks such as CDs, DVDs, HD-DVDs and BDs is being increasingly used in more and more applications. The corresponding demand for higher and higher information density (information per area) has given rise to a multitude of different technologies, each technology with various associated advantages and problems.

Conventionally, the information on the optical carrier is arranged in spiral-like tracks with the information being grouped in blocks, each block having sectors with a header section, a data section, and an error correction code (eec) section. The header section typically contains information regarding ID fields, addresses etc.

For the DVD-RAM format there are wobbled grove and land tracks where phase changing recording material is used at the centers of the grooves and lands so as to obtain the highest possible recording density. The header regions are typically arranged with four headers grouped together two and two, the two header groups being offset half a track pitch in opposite directions relative to each other and to the groove/land center track position. Furthermore, at the intersection of each revolution of groove and land the last sector groove (land) connects to the first sector of the land (groove) and at the same time the polarity of the two header groups are changed. In FIG. 1, a schematic illustration of the DVD-RAM format structure is shown. Going from header region I to header region II there is no change of polarity, whereas the header region III has a change of polarity relative to header regions I and II as is noted from the relative positions of the header groups H12 and H34. The vertical bar A to the left of header region III indicates an end of the loop. The header regions of each sector have the same embossed pit/land structure as the DVD-ROM format, and the headers are also known as complementary allocated pit addresses (CAPA's). In FIG. 1, the wobbled structure in the elongated direction of the lands 30 and grooves 31 is omitted for clarity. More details about the DVD-RAM format and in particular the header sections of the DVD-RAM format may be found in the ECMA 272 Standard, which is hereby incorporated in its entirety.

When the laser beam reading the carrier is positioned in the header regions, the respective control loops for focus error (FE) and radial error (RE) for maintaining the laser beam correctly positioned on the track should not be active, and hence the optical drive system needs a header signal for indicating that the laser beam is positioned in such a header region. Similarly, the optical drive system needs a land-groove transition signal as the laser beam traverses a header region where a land changes to a groove, or vice versa, in order to change the radial error tracking from a land to a groove scheme, or vice versa.

US patent publication 2005/002508 A1 discloses a method of generating such header and groove/land signals using differential phase detection (DPD) technology. The method initially sets first and second threshold level. The method applies a first and a second transition flag, wherein the first transition flag is enabled when the phase difference signal is greater than the first threshold level, and the second transition flag is enabled when the phase difference signal is smaller than the second threshold level. The method finally generates a header flag signal according to the first and second transition flag signal.

This method suffers from the disadvantage that the first and second threshold levels must be set in advance, i.e. during the design phase or by calibration under manufacturing.

Therefore this method may yield incorrect header signals if for some reason the DPD levels at the header region are inappropriate for detection with this method. This may be the case if there is beam landing, as this will give an offset error to the DPD signal.

### OBJECT AND SUMMARY OF THE INVENTION

It is an object of the invention to propose a more efficient and/or reliable method of detecting a header region.

Accordingly, the invention preferably seeks to mitigate, alleviate or eliminate one or more of the above-mentioned disadvantages singly or in any combination. In particular, it may be seen as an object of the present invention to provide a method that solves the above mentioned problems of the prior art with obtaining a robust header region signal.

This object and several other objects are obtained in a first aspect of the invention by providing a method of detecting a header region for a writeable optical carrier, the method comprising the steps of:
obtaining a data signal from the optical carrier,
low pass filtering the data signal for a pre-determined time constant, and
comparing the low pass filtered data signal to a dynamically determined threshold level,
   wherein a positive indication of a header region is obtained if the low pass filtered data signal is above the dynamically determined threshold level.

The invention is particularly, but not exclusively, advantageous for obtaining a stable and robust method of detection of a header region because the threshold level is dynamically determined, i.e. the threshold level may be adjusted depending on various parameters such as the RF amplitude itself, the reading speed, the clock frequency, etc. Furthermore, the method has the benefit that there is no immediate need to decode the information stored in the header region in order to detect the header region. Thus, if e.g. the focus settings of the optical drive are not optimized, for example during start-up or interruptions, it is nevertheless possible to detect a header region by application of the present invention.

In an advantageous embodiment, upon a positive indication of a header region, the method further comprises the steps of:
performing a first summation of a push-pull signal in the a first part of the header region resulting in a first accumulated pull-push signal,
upon a change in the polarity of the push-pull signal, performing a second summation of the push-pull signal in a second part of the header region resulting in a second accumulated pull push signal,
obtaining a polarity signal by comparing the first accumulated push-pull signal and the second accumulated push-pull signal, and
comparing the said polarity signal to a previous polarity signal so as to provide an indication of a land-groove transition.

This embodiment is particularly but not exclusively advantageous for obtaining an indication that a land-groove transition has taken place when passing a header region at a substantially unchanged radial distance on the optical carrier in a simple and very effective manner by utilizing the push-pull signal from the current and previous header region. Similarly to the header detection method there is also no need to decode any information stored in the header regions in order to obtain an indication of a land-groove transition. This may be advantageous under non-optimal settings of readout from the optical carrier in the optical drive.

Beneficially, at least one of the above steps may be performed in the digital domain in order to ease processing of the method. Additionally, the data signal may be averaged prior to being low pass filtered so as to obtain a more stable signal.

Advantageously, the dynamic threshold level may be determined by analysing the data signal for a pre-determined period of time, such as a time in the interval from 1 millisecond to 20 milliseconds. The period of time may depend on the rotational speed of the carrier. Additionally, the threshold level may be determined by utilising an upper value and a lower value of the data signal during the pre-determined period of time.

In order to detect a land-groove transition, the polarity signal may have the same sign as the previous polarity signal indicating that a land groove transition has not taken place. Additionally or alternatively, the polarity signal may have the opposite sign of the previous polarity signal indicating that a land groove transition has taken place.

In a second aspect, the invention relates to an optical drive capable of detecting a header region of an associated writeable optical carrier, the optical drive comprising:
photo detection means and analysing means for obtaining a data signal from the optical carrier,
filtering means for low pass filtering the data signal for a pre-determined time constant, and
analysing means for comparing the low pass filtered data signal to a dynamically determined threshold level,
   wherein a positive indication of a header region is obtained if the low pass filtered data signal is above the dynamically determined threshold level.

In a third aspect, the invention relates to a computer program product being adapted to enable a computer system comprising at least one computer having data storage means associated therewith to control an optical recording drive according to the first aspect of the invention.

This aspect of the invention is particularly, but not exclusively, advantageous in that the present invention may be implemented by a computer program product enabling a computer system to perform the operations of the first aspect of the invention. Thus, it is contemplated that some known optical recording drive may be changed to operate according to the present invention by installing a computer program product on a computer system controlling the said optical recording drive. Such a computer program product may be provided on any kind of computer readable medium, e.g. a magnetically or an optically based medium, or through a computer based network, e.g. the Internet.

The first, second and third aspect of the present invention may each be combined with any of the other aspects. These and other aspects of the invention will be apparent from and elucidated with reference to the embodiments described hereinafter.

### BRIEF DESCRIPTION OF THE DRAWINGS

The present invention will now be explained, by way of example only, with reference to the accompanying Figures, where

FIG. 1 is a schematic illustration of the DVD-RAM format,

FIG. 2 shows a diagram of an embodiment of an optical drive according to the present invention,

FIG. 3 is a block diagram of the processing unit of the optical drive shown in FIG. 2,

FIG. 4 is a graph showing the data signal (RF) from a header region,

FIG. 5 schematically shows inter alia push-pull signals and polarity signals derived thereof from three header regions, and

FIG. 6 is a flow-chart of a method according to the invention.

### DETAILED DESCRIPTION OF THE INVENTION

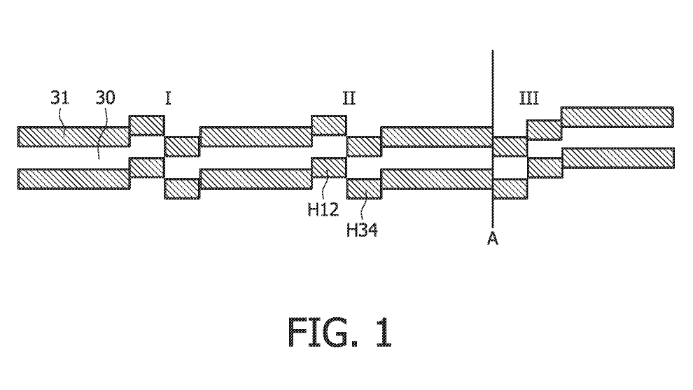

FIG. 1 is a schematic illustration of the DVD-RAM format. The present invention is particularly suited for application for an optical carrier having a format according to the DVD-RAM standard, but the present application is by no means limited to this specific format and the present invention may also find application for other formats. The header sections I, II and III shown in FIG. 1 are arranged with four headers grouped two by two, the two header groups H12 and H34 being offset half a track pitch in opposite direction relative to each other and to the groove 31 and land 30 center track position. Furthermore, at the intersection A of each revolution of groove 31 and land 30, the last sector groove (land) connects to the first sector of the land (groove) and at the same time the polarity of the two header groups H12 and H34 are changed. Going from header region I to header region II there is no change of polarity, whereas header region III has a change of polarity relative to header regions I and II as it is noted from the relative positions of header groups H12 and H34. The vertical bar A to the left of header region III indicates an end of the loop or revolution of the track. In FIG. 1, the wobbled structure in the elongated direction of the lands 30 and grooves 31 is omitted for clarity.

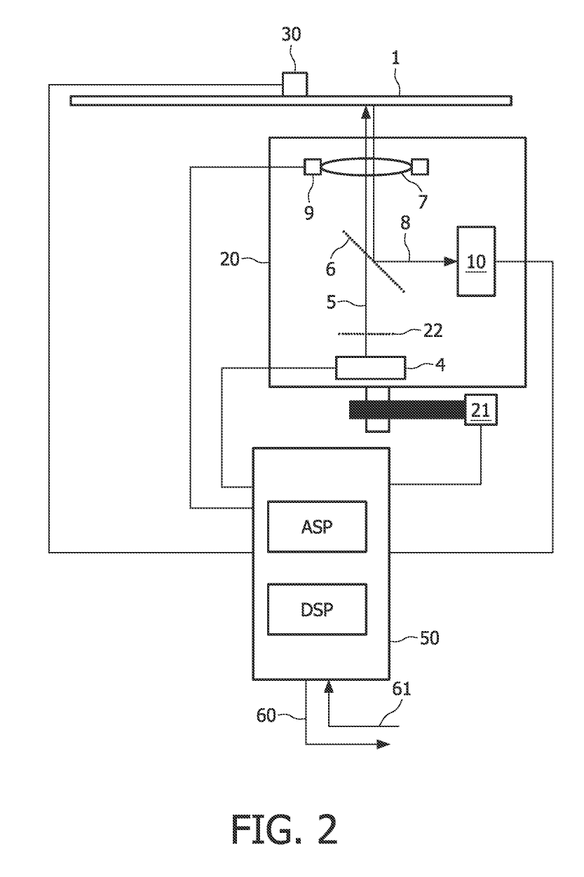

FIG. 2 shows an optical apparatus or drive and an optical information carrier 1 according to the invention. The carrier 1 is fixed and rotated by holding means 30.

The carrier 1 comprises a material suitable for recording information by means of a radiation beam 5. The recording material may, for example, be of the magneto-optical type, the phase-change type, the dye type, metal alloys like Cu/Si or any other suitable material. Information may be recorded in the form of optically detectable regions, also called marks for rewriteable media, on the carrier 1.

The apparatus comprises an optical head 20, sometimes called an optical pick-up (OPU), the optical head 20 being displaceable by actuation means 21, e.g. an electric stepping motor. The optical head 20 comprises a photo detection system 10, a radiation source 4, a beam splitter 6, an objective lens 7, and lens displacement means 9 capable of displacing the lens 7 both in a radial direction of the carrier 1 and in the focus direction. The optical head 20 may also comprise beam splitting means 22, such as a grating or a holographic pattern capable of splitting the radiation beam 5 into at least three components for use in the three spot differential push-pull radial tracking or any other applicable control method. For clarity reason, the radiation beam 5 is shown as a single beam after passing through the beam splitting means 22. Similarly, the radiation 8 reflected may also comprise more than one component, e.g. the three spots and diffractions thereof, but only one beam 8 is shown in FIG. 2 for clarity.

The function of the photo detection system 10 is to convert radiation 8 reflected from the carrier 1 into electrical signals. Thus, the photo detection system 10 comprises several photo detectors, e.g. photodiodes, charged-coupled devices (CCD), etc., capable of generating one or more electric output signals. The photo detectors are arranged spatially to one another and with a sufficient time resolution so as to enable detection of error signals, i.e. focus error FE and radial tracking error RE. The focus error FE and radial tracking error RE signals are transmitted to the processor 50 where a commonly known servomechanism operated by usage of PID control means (proportional-integrate-differentiate) is applied for controlling the radial position and focus position of the radiation beam 5 on the carrier 1.

The photo detection system 10 can also output a read signal or RF signal representing the information being read from the carrier 1 to the processor 50. The read signal may possibly be converted to a central aperture (CA) signal by a low-pass filtering of the RF signal in the processor 50.

The radiation source 4 for emitting a radiation beam or a light beam 5 can for example be a semiconductor laser with variable power, possibly also with variable wavelength of radiation. Alternatively, the radiation source 4 may comprise more than one laser. In the context of the present invention, the term “light” is considered to comprise any kind of electromagnetic radiation suitable for optical recording and/or reproduction, such as visible light, ultraviolet light (UV), infrared light (IR) etc.

The optical head 20 is optically arranged so that the radiation beam 5 is directed to the optical carrier 1 via a beam splitter 6 and an objective lens 7. Radiation 8 reflected from the carrier 1 is collected by the objective lens 7 and, after passing through the beam splitter 6, falls on a photo detection system 10 which converts the incident radiation 8 to electric output signals as described above.

The processor 50 receives and analyses first signals from the photo detection means 10. The processor 50 can also output control signals to the actuation means 21, the radiation source 4, the lens displacement means 9, and the rotating means 30 as schematically illustrated in FIG. 2. Similarly, the processor 50 can receive data, indicated at 61, and the processor 50 may output data from the reading process as indicated at 60. As shown in FIG. 2, the processor 50 principally comprises two parts; a first processing means being an analog signal processor ASP (also called RF processor) and second processing means being a digital signal processor DSP.

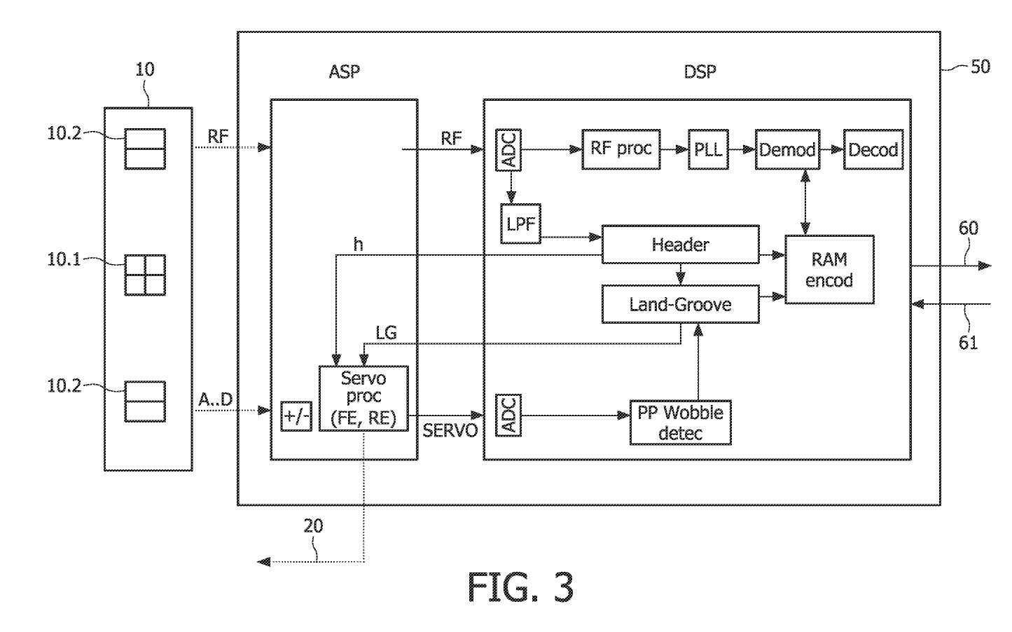

FIG. 3 is schematic block diagram of the processor 50 of an optical apparatus shown in FIG. 2. Additionally, the photo detection means 10 is shown to the left of the processor 50 with a schematically drawing of the central photo detector 10.1 divided into four sections for the central beam 8 and two neighboring photo detectors 10.2, each divided into two sections, for satellite beams of the central beam 8.

From the photo detection means 10 a first signal, termed RF in FIG. 3, is transmitted to the processor 50. Processing of this data signal trough the processor 50 defines an RF channel or an RF data path as indicated in the upper part of the processor 50. Normally, the first RF signal is the sum of light intensities incident on the central detector 10.1.

From the photo detection means 10 another signal, termed A . . . D in FIG. 3, is also transmitted to the processor 50. The A . . . D signals comprise separate components of the different photo detector sections of the photo detectors 10.1 and 10.2 for subsequent use in focus error tracking, radial error tracking, a wobble signal, synchronizing with write clock obtaining mirror signals etc. Processing of the A . . . D signal through the processor 50 defines an auxiliary channel or an auxiliary data path as indicated in the lower part of the processor 50.

In the upper channel, the RF signal may be initially amplified in a variable gain amplifier VGA (not shown) and transmitted to the DSP for initial analog to digital conversion in the analog to digital converter ADC. Subsequently, in the digital domain the RF signal is processed in the block RF proc applying a phase lock loop PLL followed by demodulation in the block Demod and decoding in the block Decod according to an appropriate decoding scheme such as the 8-16 RLL (2, 10) modulation code.

The digital RF signal is also transmitted to the header detection block Header after being low pass filtered in the block LPF. In the Header block, there is performed a comparison of the low pass filtered data signal LPF_RF to a dynamically determined threshold level RF_th. A positive indication of a header region I, II, or III is obtained if the low pass filtered data signal LPF_RF is above the dynamically determined threshold level. If positive a logic signal h is set to 1, this header signal h is then transmitted to and applied by the servo processing of the radial error RE and focus error FE signals in the block Servo Proc of the auxiliary channel in the ASP as indicated in FIG. 3.

If a header region is detected, i.e. h=1, an advantageous embodiment further applies a push-pull signal (PP) to detect a land-groove transition in the block Land-Groove. The push signal is also applied for wobble detection for addressing and/or timing information in the block PP wobble detec. In the Land-Groove block there is performed a first summation of a push-pull signal (PP) in a first part H12 of the header region I, II or III resulting in a first accumulated pull-push signal APP1, sometimes known as the energy of the push-pull signal. Due to the header format there will be a change in the polarity of the push-pull signal (PP), and then a second summation of the push-pull signal (PP) in a second part H34 of the header region is undertaken resulting in a second accumulated pull push signal APP2. Subsequently, a polarity signal DPII is obtained by comparing, e.g. by simple subtraction, the first accumulated push-pull signal PP1 and the second accumulated push-pull signal (PP2). Finally, a comparison is made between the said polarity signal DPII and a previous polarity signal DPI so as to provide an indication of a land-groove transition. If positive, a logic signal LG is set as high, i.e. LG=1. In terms of mathematical relations this may be formulated as follows;

APP1=Σ_{H12}PP and APP2=Σ_{H34}PP, and

DPi=APP1−APP2 for i={I, II, III},

sign DPi=sign DP(i−1); LG=0, and

sign DPi≠sign DP(i−1); LG=1.

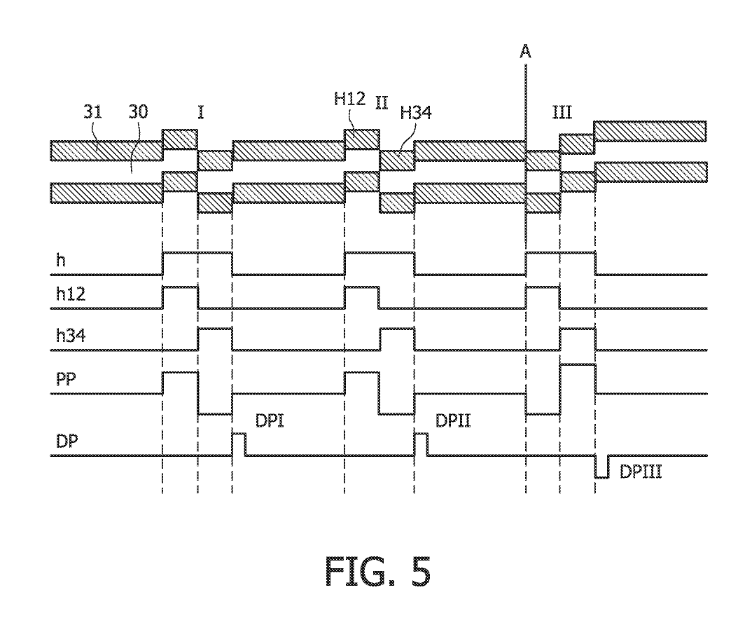

Referring to FIG. 1 again, the polarity signal DPII from the header region II has the same sign as the previous polarity signal DPI from the header region I indicating that a land groove transition has not taken place. Oppositely, the polarity signal DPIII from the header region III has the opposite sign of the previous polarity signal DPII from the header region II indicating that a land groove transition has taken place. This is illustrated in FIG. 5.

The change between the two header groups H12 and H34 is detected in the Land-Groove block by monitoring the polarity of the PP signal. Corresponding logic signals h12 and h34, respectively, are associated with the two header groups H12 and H34. This is also illustrated in more detail in FIG. 5.

In the lower channel of FIG. 3, signals A . . . D are transmitted to a sum difference circuit+/−for processing of the relevant first signals A . . . D for radial tracking, e.g. a push pull signal PP. The PP signal is transmitted to the DSP for initial analog to digital conversion in the lower ADC of the DSP and subsequent wobble detection.

As shown in FIG. 3, the header information and the land-groove transition information obtainable by the present invention may also be applied in the RAM encoding process in the block RAM encod.

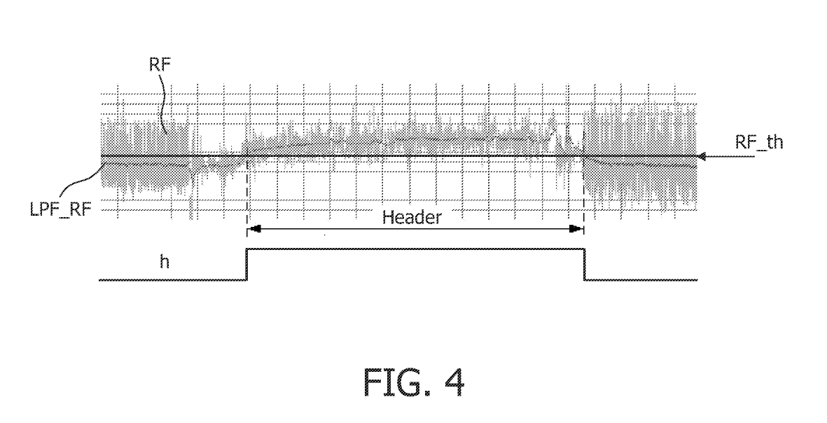

FIG. 4 is a graph showing the data signal RF from a header region indicated by the double arrow and the logic signal h being high. The data signal RF is shown together with a low pass filtered data signal LPF_RF with no high frequency component. The low pass filtering of the example is performed with a cut-off frequency of the LPF_RF from 50 kHz at low disc speed up to 500 kHz at high disc speed. The cut-off frequency of the LPF to set the threshold level is from 50 Hz (low disc speed) to 1000 Hz (high disc speed), so the time frame is approximately from 1/50 Hz (20 ms) to 1/1000 Hz (1 ms). Thus, the time frame for setting the RF threshold is much larger compared to the time to travel a header region I, II, or III. There are typically 30 to 50 header regions per rotation of a carrier or disk. The minimum time frame to set the RF threshold is that there are at least two header regions detected in this time frame.

The dynamically determined threshold level RF_th may change as e.g. the temperature increases when recording (or reading) due to the large power consumption of the laser 4. The laser efficiency is lowered with the increasing temperature. This means that the amplitude of the RF signal reduces with increasing temperature (or time). The dynamically controlled loop to set RF threshold can, at least partly, solve this problem.

The threshold level RF_th is determined by the upper and lower level difference multiplied by 0.75 as this procedure has shown to be a stable and reliable way of detecting a header region I, II, or III. Thus, the threshold may mathematically be given as

RF_{—}th=0.75·(Max(RF)−Min(RF))

However, the pre-factor for multiplication by the subtracted RF value may preferably be any value within the interval of 0.5 to 0.85, such as 0.55, 0.60, 0.65, 0.70, 0.75 or 0.80. Other mathematical models for dynamically setting the threshold level of the data signal RF so as to obtain an appropriate threshold level for detecting the header region may also be applied. The threshold level is a compromise between a too low value resulting in false positive header detection and a too high level giving false negative header detection.

FIG. 5 schematically shows logic signals h, h12, 134, push-pull signals PP, and polarity signals DPI, DPII, DPII derived thereof from the three header regions I, II and III, respectively. The header format in the upper part of FIG. 5 is identical to the format shown in FIG. 1. The dotted, vertical lines in FIG. 4 indicate substantially concurrent events as the laser beam 5 travels along a groove 31 or a land 30.

As mentioned above, the upper three curves named h, h12, and h34 are the header region signal and the signals associated with the subdivision of the header region I, II or III into the two header regions H12 and H34, respectively.

The push-pull signal PP is also shown schematically on a coarse scale. On a closer scale, the PP signal contains high frequency variation from the wobbling and fluctuations around zero radial offset. Notice that the radial error RE and focus error FE control loops are not active in the header regions I, II, and III. As seen in the PP curve the header regions I and II give rise to the same kind of PP signal, whereas the header region III has an opposite curve shape of the PP signal. Consequently, this will give rise to two different polarity signals DPi i={I, II, III} as indicated in the lower curve DP in FIG. 5. The polarity signals DPi are calculated immediately after the laser beam 5 leaves header region I, II or III in order to provide header and land-groove transition information for the control of the optical drive.

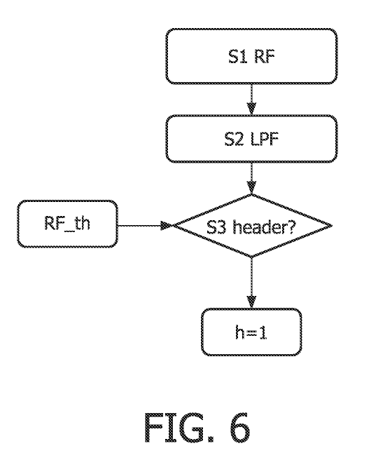

FIG. 6 is a flow-chart of a method according to the invention for detecting a header region I, II, or III for a writeable optical carrier 1. The method comprises the steps of:

S1 obtaining a data signal RF from the optical carrier 1,
S2 low pass filtering the data signal RF for a pre-determined time constant, and
S3 comparing the low pass filtered data signal LPF_RF to a dynamically determined threshold level RF_th,
and a positive indication of a header region I, II, or III is obtained, if the low pass filtered data signal LPF_RF is above the dynamically determined threshold level RF_th, thus, the header logic value is set to positive; h=1.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. A method of detecting a header region (I, II, III) for a writeable optical carrier (1), the method comprising the steps of:
obtaining a data signal (RF) from the optical carrier,
low pass filtering the data signal (RF) for a pre-determined time constant, and
comparing the low pass filtered data signal (LPF_RF) to a dynamically determined threshold level (RF_th),
wherein a positive indication of a header region (I, II, III) is obtained if the low pass filtered data signal (LPF_RF) is above the dynamically determined threshold level (RF_th).

2. A method according to claim 1, wherein the method upon a positive indication of a header region (I, II, III) further comprising the steps of:
performing a first summation of a push-pull signal (PP) in the a first part (h12) of the header region resulting in a first accumulated pull-push signal (APP1),
upon a change in the polarity of the push-pull signal (PP), performing a second summation of the push-pull signal (PP) in a second part (h34) of the header region resulting in a second accumulated pull-push signal (APP2),
obtaining a polarity signal (DPII) by comparing the first accumulated push-pull signal (PP1) and the second accumulated push-pull signal (PP2), and
comparing the said polarity signal (DPII) to a previous polarity signal (DPI) so as to provide an indication of a land-groove transition.

3. A method according to claim 1, wherein at least one of the steps is performed in the digital domain.

4. A method according to claim 1, wherein the data signal (RF) is averaged prior to being low pass filtered.

5. A method according to claim 1, wherein the dynamic threshold level (RF_th) is determined by analysing the data signal (RF) for a predetermined period of time (T).

6. A method according to claim 5, wherein the threshold level (RF_th) is determined by utilising an upper value and a lower value of the data signal (RF) during the pre-determined period of time (T).

7. A method according to claim 2, wherein the polarity signal (DPII) has the same sign as the previous polarity signal (DPI) indicating that a land groove transition has not taken place.

8. A method according to claim 2, wherein the polarity signal (DPIII) has the opposite sign of the previous polarity signal (DPII) indicating that a land groove transition has taken place.

9. An optical drive capable of detecting a header region (I, II, III) of an associated writeable optical carrier (1), the optical drive comprising:
photo detection means (10) and analysing means (50) for obtaining a data signal (RF) from the optical carrier (1),
filtering means (50, LPF) for low pass filtering the data signal (RF) for a pre-determined time constant, and
analysing means (50, Header) for comparing the low pass filtered data signal (LPF_RF) to a dynamically determined threshold level (RF_th),
wherein a positive indication of a header region (I, II, III) is obtained, if the low pass filtered data signal (LPF_RF) is above the dynamically determined threshold level (RF_th).

10. A computer program product being adapted to enable a computer system comprising at least one computer having data storage means associated therewith to control an optical drive according to claim 1.
